(19) United States
(12) Patent Application Publication
(10) Pub. No.: US 2011/0149767 A1
(43) Pub. Date: Jun. 23, 2011

(54) METHOD AND SYSTEM FOR MANAGING NODE IDENTIFICATION

(75) Inventors: Kye Seon LEE, Daejeon (KR); So Young Hwang, Busan (KR); Seong Soon Joo, Daejeon (KR); Jong Suk Chae, Daejeon (KR)

(73) Assignee: Electronics and Telecommunications Research Institute, Daejeon (KR)

(21) Appl. No.: 12/886,670

(22) Filed: Sep. 21, 2010

(30) Foreign Application Priority Data
Dec. 18, 2009 (KR) 10-2009-0127116

(51) Int. Cl. H04L 12/26; H04W 72/04

(52) U.S. Cl. 370/252; 370/329

(57) ABSTRACT

Provided is a method and system for managing an identification (ID) of a widely moved sensor node. The method includes recognizing, at a gateway, a node to check an ID of the node, allocating an ID of the gateway as the ID of the node when the ID of the node checked by the gateway is null, sending the ID of the node to a management server when the ID of the node checked by the gateway is not null and is different from the ID of the gateway, and when a new ID is received from the management server, allocating the new ID as the ID of the node.

### CROSS-REFERENCE TO RELATED APPLICATION

This application claims priority to and the benefit of Korean Patent Application No. 10-2009-0127116, filed Dec. 18, 2009, the disclosure of which is incorporated herein by reference in its entirety.

### BACKGROUND

1. Field of the Invention

The present invention relates to a method and system for managing a node identification (ID), and more particularly, to determining whether or not a sensor node has moved when registered to allocate an ID only to the moved node.

2. Discussion of Related Art

Standards associated with a wireless sensor network (WSN) have been published, and various techniques for efficiently establishing a WSN have been developed. Sensor nodes constituting a WSN wirelessly gain access to the WSN for communication with each other.

To technically allow sensor nodes belonging to a WSN to move to another WSN, it is essential to give the sensor nodes globally unique IDs, and discriminate an originally registered location from a moved location.

Sensor nodes complying with WSN standards such as institute of electrical and electronics engineers (IEEE) 802.15.4 media access control (MAC) or ZigBee Network have a 16-bit short address used within a single personal area network (PAN) at a MAC or network layer. It is insufficient to use this 16-bit short address as the unique ID, because it enables the sensor nodes to be discriminated only within the single PAN.

There is another method of allocating the IDs to all the sensor nodes using a numbering method. In this method, it is essential to previously allocate an ID when each sensor node is subscribed, and provide a manager for this allocation.

Further, a central management server may allocate IDs using an automatic numbering method when the sensor nodes are registered. However, since it is assumed that numerous sensor nodes exist in a WSN, the length of an ID is inevitably increased to allocate IDs to these numerous sensor nodes. For this reason, a message processing capability is lowered, and a high-performance computing capability is required. Thus, it is necessary to minimize this requirement.

### SUMMARY OF THE INVENTION

The present invention is directed to a method of allocating an identification (ID) to a moving sensor node.

One aspect of the present invention is to provide a method of managing a node ID, which includes: recognizing, at a gateway, a node to check an ID of the node; allocating an ID of the gateway as the ID of the node when the ID of the node checked by the gateway is null; sending the ID of the node to a management server when the ID of the node checked by the gateway is not null and is different from the ID of the gateway; and when a new ID is received from the management server, allocating the new ID as the ID of the node.

The ID of the node may include a gateway-type ID and a node-type ID, and the new ID received from the management server may be the node-type ID. The method may further include: checking, at the management server, the received ID of the node; and generating and sending the new ID when the ID of the node checked by the management server is the gateway-type ID. When generating the new ID, the management server may designate the gateway-type ID checked by the management server as an ID of a home gateway of the node, and designate the gateway requesting to check the ID of the node as an ID of a visited gateway of the node. The management server may store the new ID, the ID of the home gateway of the node, and the ID of the visited gateway of the node. The method may further include updating the ID of the visited gateway of the node stored in the management server when the ID of the node checked by the management server is the node-type ID. The method may further include, when the ID of the node checked by the gateway is null, allocating, at the gateway, a node name to be used in a network managed by the gateway, and storing the node name, a personal area network (PAN) ID of the node, and a short address of the node in a table. The method may further include, when the ID of the node checked by the gateway is identical to the ID of the gateway, considering it as a re-registration in the network managed by the gateway, and updating information about the node. The node may be a sensor node.

Another aspect of the present invention is to provide a system of managing a node ID, which includes a gateway that recognizes a node, allocates its own ID as an ID of the node when the ID of the node is null, and sends the ID of the node to a management server when the ID of the node is not null and is different from its own ID.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a conceptual view illustrating a process of a sensor node moving to be registered with another sensor network;

FIGS. 2A through 2C illustrate a gateway information table and a sensor node information table according to an exemplary embodiment of the present invention;

FIGS. 3A and 3B illustrate a sensor node information table and a gateway information table after a sensor node moves;

FIG. 4 is a flowchart illustrating a process of a gateway registering a sensor node according to an exemplary embodiment of the present invention;

FIG. 5 is a flowchart illustrating a process of a management server managing the identification (ID) of a sensor node according to an exemplary embodiment of the present invention; and

FIG. 6 illustrates how a management server of the Internet discriminates a gateway-type ID from a node-type ID using the value of a “Node Id” field.

### DETAILED DESCRIPTION OF PREFERRED EMBODIMENTS

Hereinafter, an exemplary embodiment of the present invention will be described in detail. However, the present invention is not limited to the embodiments disclosed below, but can be implemented in various types. Therefore, the present embodiment is provided for complete disclosure of the present invention and to fully inform the scope of the present invention to those ordinarily skilled in the art.

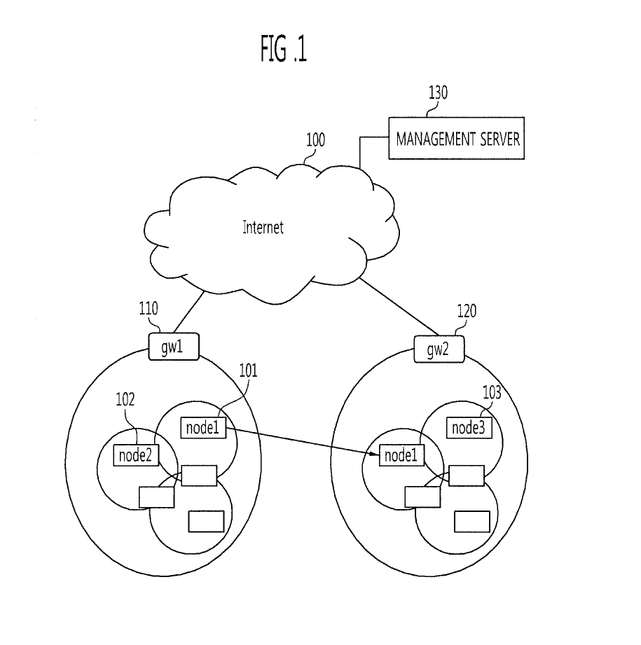

FIG. 1 is a conceptual view illustrating a process of a sensor node moving to be registered with another sensor network. A management server 130, a first gateway 110, and a second gateway 120 are connected to the Internet 100. A sensor network is connected to the Internet 100 through the first gateway 110, and includes a first sensor node 101 and a second sensor node 102. A sensor network is connected to the Internet 100 through the second gateway 120, and includes a third sensor node 103.

Referring to FIG. 1, the first sensor node 101 is connected to the sensor network of the first gateway 110, and then moves to the sensor network of the second gateway 120.

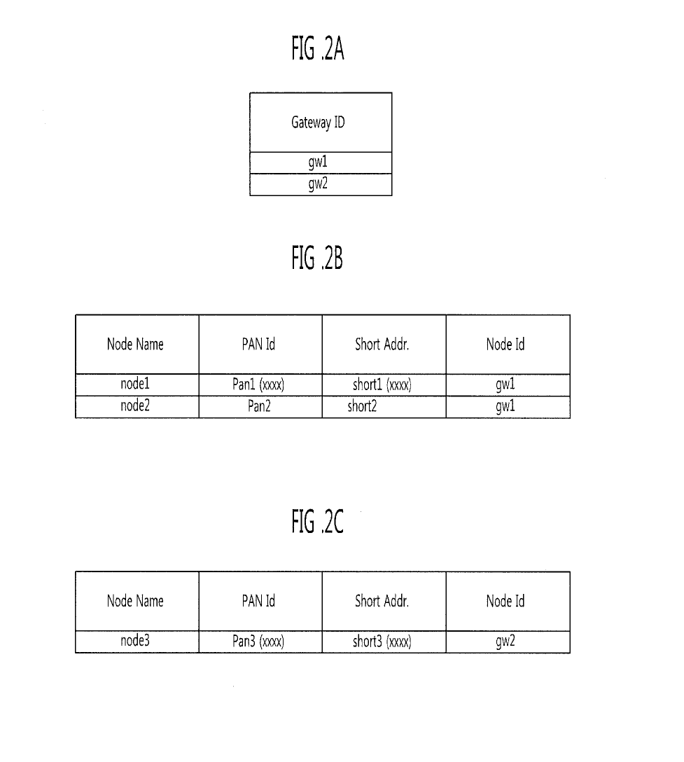

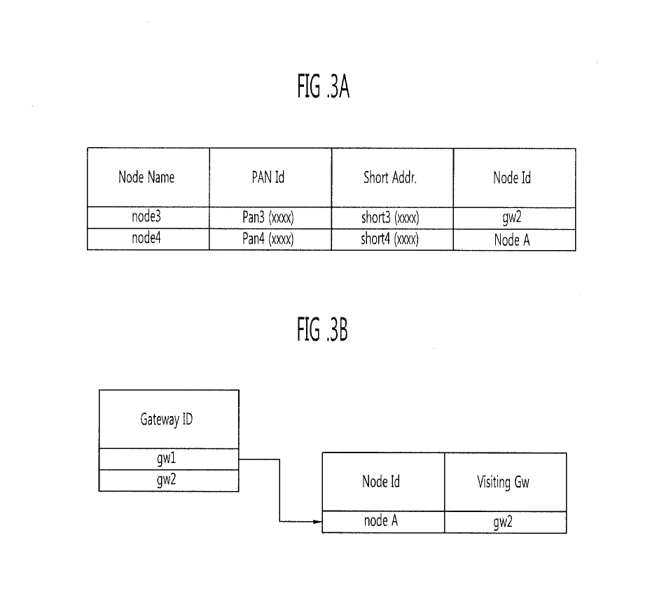

FIGS. 2A through 2C illustrate a gateway information table and a sensor node information table according to an exemplary embodiment of the present invention. FIGS. 2A through 2C explicitly show management tables which the Internet 100, the first gateway 110, and the second gateway 120 have before the first sensor node 101 moves.

The table of FIG. 2A is a gateway information table for sensor network management which the management server 130 of the Internet 100 has. In the gateway information table, “gw1” and “gw2” are gateway identification (ID) that is allocated by the Internet to identify the sensor network.

The table of FIG. 2B is a sensor node information table which the first gateway 110 manages. In the sensor node information table, a node name is allocated by the gateway, and the value of a personal area network (PAN) ID field “PAN Id” and the value of a short address field “Short Addr.” are address values allocated in the sensor network complying with the wireless sensor network (WSN) standard. The gateway sorts and manages the sensor nodes according to node name. A value of a node ID field “Node Id” of the sensor node is allocated according to an exemplary embodiment of the present invention. The value “gw1” is allocated to a sensor node gaining first access to the first gateway 110 among the several gateways.

The table of FIG. 2C is the sensor node information table which the second gateway 120 manages. The gateway ID “gw2” is recorded in the node ID field “Node Id” of the sensor node gaining first access to the second gateway 120.

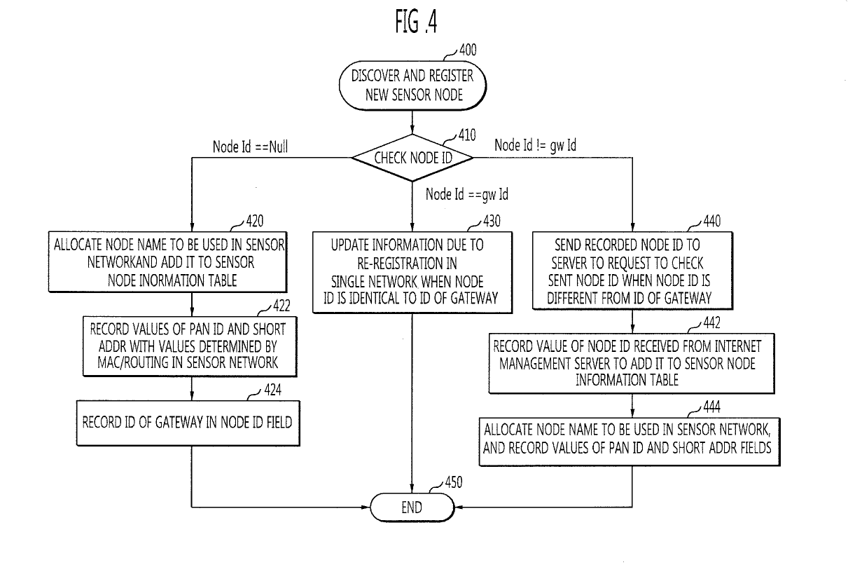

FIGS. 3A and 3B illustrate a sensor node information table and a gateway information table after a sensor node moves. In detail, these tables are management tables which the second gateway 120 and the Internet 100 have after the first sensor node 101 moves from the first gateway 110 to the second gateway 120.

The table of FIG. 3A is the sensor node information table which the second gateway 120 manages. When a new node makes a request for registration in the second gateway 120, the second gateway or 120 checks that a value of the “Node Id” field of the new node is not null and is different from the value “gw2” of its own gateway ID field, and requests the management server 130 of the Internet to check the value of the “Node Id” field (“gw1”). The second gateway 120 receives a response that the value of the “Node Id” field of the new node is “Node A,” and then adds it to the sensor node information table. A value of the “Node Name” field is allocated with a value of “node 4” by the second gateway 120, and the values of the “PAN Id” and “Short Addr.” fields are recorded with address values allocated when the sensor network is established. The value of the “Node Id” field is recorded with the value “Node A” allocated from the Internet. When the value of the “Node Id” field of the new node is null, the second gateway 120 allocates the value “gw2” of its own gateway ID field as the value of the “Node Id” field of the new node.

The table of FIG. 3B is the gateway information table which the management server 130 of the Internet manages. When receiving a request to check the value of the “Node Id” field (“gw1”) from the second gateway gw2, the management server 130 checks that the value “gw1” is a value of the gateway ID field in the gateway information table. The management server 130 manages the gateway information table to look at the value “gw1” that is the value of the “Node Id” field, to find that no unique ID has been allocated to the moving sensor node up to now, to generate and allocate a new value of the “Node Id” field, and to search for the new value in the future with reference to the value “gw1” of the corresponding “Node Id” field of the gateway information table.

In detail, the value “gw1” of the gateway ID field which the sensor node has is designated as the value of the “Node Id” field of the sensor node for a home gateway, and the value “gw2” of the gateway ID field of the gateway that requests to check the value of the “Node Id” field of the sensor node is designated as the value of the “Node Id” field of the sensor node for a visited gateway. The new value “Node A” of the “Node Id” field of the sensor node, the value “gw1” of the gateway ID field of the home gateway of the sensor node, and the value “gw2” of the gateway ID field of the visited gateway of the sensor node are stored.

FIG. 4 is a flowchart illustrating a process of a gateway registering a sensor node according to an exemplary embodiment of the present invention. In detail, this flowchart explicitly shows a process of a gateway discovering a new sensor node to register and manage it with a sensor node information table.

First, when a gateway discovers a new sensor node (S400), the gateway checks the value of a “Node Id” field of the new sensor node (S410).

When a value of the “Node Id” field of the new sensor node is null, the new sensor node is an originally registering sensor node. Thus, the gateway allocates a value of the “Node Name” field that is to be used in the sensor network managed by a present gateway, and adds it to a sensor node information table (S420). Values of the “PAN Id” and “Short Addr.” fields are recorded with values found when the sensor node is discovered (S422). The gateway records its own gateway ID in the “Node Id” field (S424).

When a value of the “Node Id” field is identical to that of the gateway ID field of the gateway, this means re-registration in the network managed by the gateway itself, and so the gateway updates information (S430).

When the value of the “Node Id” field is not null and is different from that of the gateway ID field of the gateway, the new sensor is a moved sensor node. Thus, the gateway sends the “Node Id” field to the Internet management server, and requests to check the “Node Id” field (S440). A value of the “Node Id” field received from the Internet management server is recorded as the value of the “Node Id” field of the sensor node (S442). The gateway allocates the “Node Name” field to be used in the sensor network, and records the values of the “PAN Id” and “Short Addr.” fields (S444).

When this procedure is completed, the sensor node registration of the gateway is finished (S450).

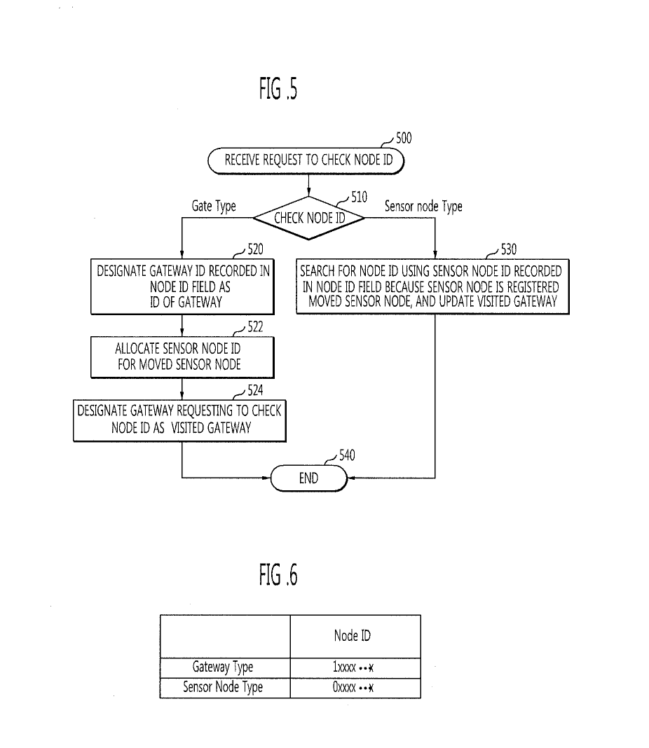

FIG. 5 is a flowchart illustrating a process of a management server managing the ID of a sensor node according to an exemplary embodiment of the present invention.

A management server of the Internet receives a request to check the “Node Id” field from a gateway (S500).

The management server checks the received “Node Id” field (S510).

When a received node ID is a gateway-type ID, the management server of the Internet designates a gateway that originally registers a sensor node using the value of the “Node Id” field as a home gateway (S520). The management server of the Internet regards the sensor node as an originally moved sensor node, and allocates a new value of the “Node Id” field (S522). The management server of the Internet regards the gateway requesting to check the “Node Id” field as a gateway which the sensor node moves to and visits (referred to as “visited gateway”), and stores information (S524).

When the received node ID is a node-type ID, the management server of the Internet updates the visited gateway (S530).

FIG. 6 illustrates how a management server of the Internet discriminates a gateway-type ID from a node-type ID using the value of a “Node Id” field.

This exemplary embodiment shows that a management server of the Internet discriminates between IDs in such a manner that a first bit is set to 1 when the management server generates a gateway-type ID, and 0 when the management server generates a node-type ID.

The aforementioned “Node Id” field needs to be stored in a sensor node. An unmoving sensor node has an ID identical to the gateway ID of the home gateway, and a “Node Id” field identical to that of the sensor node management table managed by the home gateway.

As described above, in an exemplary embodiment of the present invention, a management server of the Internet can allocate unique IDs for discriminating and managing moving sensor nodes. Unlike a method of allocating IDs to all the sensor nodes respectively, the ID is allocated only to a moving sensor node for management, so that the amount of network traffic can be reduced. Further, the number of targets to be managed is reduced, so that it is possible to reduce a length of the ID, and to relieve computing complexity.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method of managing a node identification (ID), comprising:
recognizing a node to check an ID of the node in a gateway;
allocating an ID of the gateway as the ID of the node when the ID of the node checked by the gateway is null;
sending the ID of the node to a management server when the ID of the node checked by the gateway is not null and is different from the ID of the gateway; and
allocating the new ID as the ID of the node when a new ID is received from the management server.

2. The method according to claim 1, wherein the ID of the node includes a gateway-type ID and a node-type ID, and the new ID received from the management server is the node-type ID.

3. The method according to claim 2, further comprising:
checking the received ID of the node in the management server; and
generating and sending the new ID when the ID of the node checked by the management server is the gateway-type ID.

4. The method according to claim 3, wherein when generating the new ID, the management server designates the gateway-type ID checked by the management server as an ID of a home gateway of the node,
designates the ID of the gateway requesting to check the ID of the node as an ID of a visited gateway of the node, and
stores the new ID, the ID of the home gateway of the node, and the ID of the visited gateway of the node.

5. The method according to claim 4, further comprising updating the ID of the visited gateway of the node stored in the management server when the ID of the node checked by the management server is the node-type ID.

6. The method according to claim 1, further comprising, when the ID of the node checked by the gateway is null, allocating, at the gateway, a node name to be used in a network managed by the gateway, and storing the node name, a personal area network (PAN) ID of the node, and a short address of the node in a table.

7. The method according to claim 6, further comprising, when the ID of the node checked by the gateway is identical to the ID of the gateway, considering it as a re-registration in the network managed by the gateway, and updating information about the node.

8. The method according to claim 1, wherein the node is a sensor node.

9. A system of managing a node identification (ID), comprising:
a gateway recognizing a node, allocating its own ID as an ID of the node when the ID of the node is null, and sending the ID of the node to a management server when the ID of the node is not null and is different from its own ID.

10. The system according to claim 9, wherein the IDs include a gateway-type ID and a node-type ID.

11. The system according to claim 10, further comprising the management server checking the ID of the node received from the gateway, and generating and sending a new node-type ID to the gateway when the checked ID is the gateway-type ID,
wherein the gateway allocates the received new node-type ID to the node.

12. The system according to claim 11, wherein, when generating the new node-type ID, the management server designates the gateway-type ID of the node as an ID of a home gateway of the node, designates the ID of the gateway requesting to check the ID of the node as an ID of a visited gateway of the node, and stores the new node-type ID, the ID of the home gateway of the node, and the ID of the visited gateway of the node.

13. The system according to claim 12, wherein the management server updates the stored ID of the visited gateway of the node when the received ID of the node is the node-type ID.

14. The system according to claim 9, wherein when the ID of the node is null, the gateway allocates a node name to be used in a network managed by the gateway, and stores the node name, a personal area network (PAN) ID of the node, and a short address of the node.
